(19) United States
(12) Patent Application Publication
(10) Pub. No.: US 2015/0039698 A1
(43) Pub. Date: Feb. 5, 2015

(54) BLIND SHARING OF CONTENT ON SOCIAL NETWORKING SERVICES

(71) Applicant: CISCO TECHNOLOGY, INC., San Jose, CA (US)

(72) Inventor: Vikram MAVALANKAR, Santa Clara, CA (US)

(73) Assignee: CISCO TECHNOLOGY, INC., San Jose, CA (US)

(21) Appl. No.: 13/957,894

(22) Filed: Aug. 2, 2013

(51) Int. Cl. H04L 12/58

(52) U.S. Cl. CPC H04L 51/32
USPC 709/206

(57) ABSTRACT

In an example embodiment disclosed herein, there is described a system and method for a user of a messaging service to create content, and designate that the content should be delivered or posted to selected recipients. The system allows the user to further designate a status for each recipient, in that a recipient may be designated as a public recipient or a private or blind recipient. An appropriate or compatible format for the content is determined for each recipient based on each recipient's status, the content is formatted in accordance with the determined format, and the content is then delivered to each recipient in the determined format.

### TECHNICAL FIELD

The present disclosure relates generally to blind or covert sharing of content on social networking services.

### BACKGROUND

Current social network services, both public and private, allow a user to create content, such as by means of a “post” or “blog”, which is then published on the social network. Along with content creation, most social networks allow the user to assign permissions to view, edit, share, and comment on the created content. After the content has been published, subscribers to the social network can see the list of recipients with whom the content was shared. In certain situations, the user may want to share the content with a number of recipients, but not have the identity of such recipients published with the content.

### BRIEF DESCRIPTION OF THE DRAWINGS

The accompanying drawings incorporated herein and forming a part of the specification illustrate the example embodiments.

FIG. 1 is a block diagram of a system for blind sharing of content via a messaging service.

FIG. 2 is a block diagram that illustrates a computer system upon which an example embodiment may be implemented.

FIG. 3 is an example of a methodology for blind sharing of content via a messaging service.

FIG. 4 is an example of a methodology for blind sharing of content via a messaging service, wherein such content includes content access permissions associated with at least one recipient.

FIG. 5 is an example of a methodology for blind sharing of content via a messaging service, wherein the content is delivered to a plurality of messaging services.

FIG. 6 illustrates an example display of shared content via a messaging service as viewed by a user that created the content in accordance with one example embodiment.

FIG. 7 illustrates an example display of shared content via a messaging service as viewed by a public recipient in accordance with one example embodiment.

FIG. 8 illustrates an example display of shared content via a messaging service as viewed by a blind recipient in accordance with one example embodiment.

FIG. 9 illustrates an example display of shared content via a messaging service as viewed by a user that created the content in accordance with one example embodiment.

FIG. 10 illustrates an example display of shared content via a messaging service as viewed by a public recipient in accordance with one example embodiment.

FIG. 11 illustrates an example display of shared content via a messaging service as viewed by a blind recipient in accordance with one example embodiment.

FIG. 12 illustrates an example of shared content via a messaging service wherein the content is shared only amongst a select group of subscribers of a messaging service in accordance with one example embodiment.

FIG. 13 illustrates an example of shared content via a messaging service wherein the content is shared to all subscribers of a messaging service in accordance with one example embodiment.

FIGS. 14A-14B illustrate examples of code for implementing an example embodiment.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment described herein, there is disclosed an apparatus comprising an interface and message generation logic coupled with the interface and operable to communicate with at least one associated messaging service. The message generation logic receives data representative of a request to send content to at least one designated recipient, the request data including identification information for each designated recipient. The message generation logic receives data representative of recipient status for each recipient, the recipient status including information as to whether such recipient is a blind recipient. The message generation logic determines a format for delivering the content to each of the recipients based on recipient status. The message generation logic formats the content for each recipient in accordance with the determined format for each recipient and the message generation logic delivers the content to each recipient in the determined format.

In an example embodiment described herein, there is disclosed a method comprising receiving data representative of a request to send content to at least one designated recipient, the request data including identification information for each designated recipient. The method also comprises receiving data representative of recipient status for each recipient, the recipient status including information as to whether such recipient is a blind recipient and a format for delivering the content to each of the recipients is determined based on recipient status. The content for each recipient is formatted in accordance with the determined format for each recipient and the content is delivered to each recipient in the determined format.

In an example embodiment described herein, there is disclosed logic encoded in a tangible, non-transitory computer readable medium for execution by a processor, and when executed operable to receive data representative of a request to send content to at least one designated recipient, the request data including identification information for each designated recipient. The logic is further operable to determine receive data representative of recipient status for each recipient, the recipient status including information as to whether such recipient is a blind recipient and a format for delivering the content to each of the recipients is determined based on recipient status. The logic is also operable to format the content for each recipient in accordance with the determined format for each recipient and deliver the content to each recipient in the determined format.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment disclosed herein, there is described a system and method for a user of a messaging service, such as Facebook or Twitter, to create content, and designate that the content should be delivered or posted to selected recipients. The system allows the user to further designate a status for each recipient, in that a recipient may be designated as a public recipient or a private or blind recipient. An appropriate or compatible format for the content is determined for each recipient based on each recipient's status, the content is formatted in accordance with the determined format, and the content is then delivered to each recipient in the determined format.

In an example embodiment, the content is displayed or published via the associated messaging service, and includes identification information associated with each public recipient, such as the user name, location, or both, in the displayed content. In an example embodiment, the system filters or blocks identification information for each private or blind recipient, such that the displayed content does not include any identification information associated with any of the blind recipients.

In an example embodiment, the messaging service may be a private messaging service or a publicly accessible messaging service. In a particular embodiment, the messaging service is a private messaging service, such as an intranet service for a company, educational institution, or other type of organization. In such an embodiment, content generated by a user of such service would be published within the particular intranet environment subject to any guidelines or restrictions relating to published content.

In another particular embodiment, the messaging service is an online social network messaging service, such as Facebook or Twitter. In such an embodiment, content generated by a user or subscriber thereof would be published on the social network in accordance with any publication guidelines set by the user or such social network messaging service. As an example, the social network service may have content standards such that certain material may not be published, such as lewd, discriminatory, or other types of inappropriate content. Further, the user may have set or be subject to certain restrictions as to what type of content may be published or with whom content may be shared. As an example, most social network services allow a user or subscriber to set specific criteria as to who may see content published by such user, such as allowing everyone to see content, allowing everyone to see only certain content, allowing only a select group of other users to see content, and the like.

In an example embodiment, when the user designates at least one recipient to receive content, such designation may include information for each recipient as to the messaging service associated with such recipient, to which messaging service such recipient is a subscriber, or to which messaging service the content should be sent for each recipient. As an example, the user may designate multiple recipients to receive the content, and the designated recipients may not all be associated with or a subscriber of the same messaging service. In that instance, the content must be delivered to a plurality of messaging services, and each messaging service will likely have its own distinct format for publishing content. In a particular embodiment, the appropriate format for delivering the content to each one of the recipients is determined further based on the messaging service associated with each recipient, the content for each recipient is formatted accordingly, and the content is delivered to each recipient via the designated messaging service.

In an example embodiment, when a user designates at least one blind recipient to receive content, such designation may include information content access rights associated with each blind recipient. The content access rights assigned to a blind recipient determine how the blind recipient may interact with the content. As an example, the content access rights assigned to a particular blind recipient may only allow the blind recipient to view the content, or may allow the blind recipient to view and provide commentary as to the content. In a particular embodiment, the content access rights for blind recipients may include viewing the content, modifying the content, forwarding at least a portion of the content to at least one additional recipient, providing additional content or commentary, or combinations thereof. In a particular embodiment, the appropriate format for delivering the content to each one of the recipients is determined further based on the content access rights associated with each recipient, the content for each recipient is formatted accordingly, and the content is delivered to each recipient.

In an example embodiment, the content published or displayed may be comprised of text based information, video content, audio content, audiovisual content, image content, or combinations thereof.

The system and method for blind sharing of content via a messaging service is suitably implemented as part of an existing mechanism for creation of content, providing update or status information, providing commentary, or other types of information to a social networking messaging service. Current social network messaging services typically use a data model which stores a list of recipients to receive content from a user as a bitmap with the associated content access rights for each recipient. It is understood that such data models will suitably be modified to support storage of blind recipients as well as the content access rights for each blind recipient.

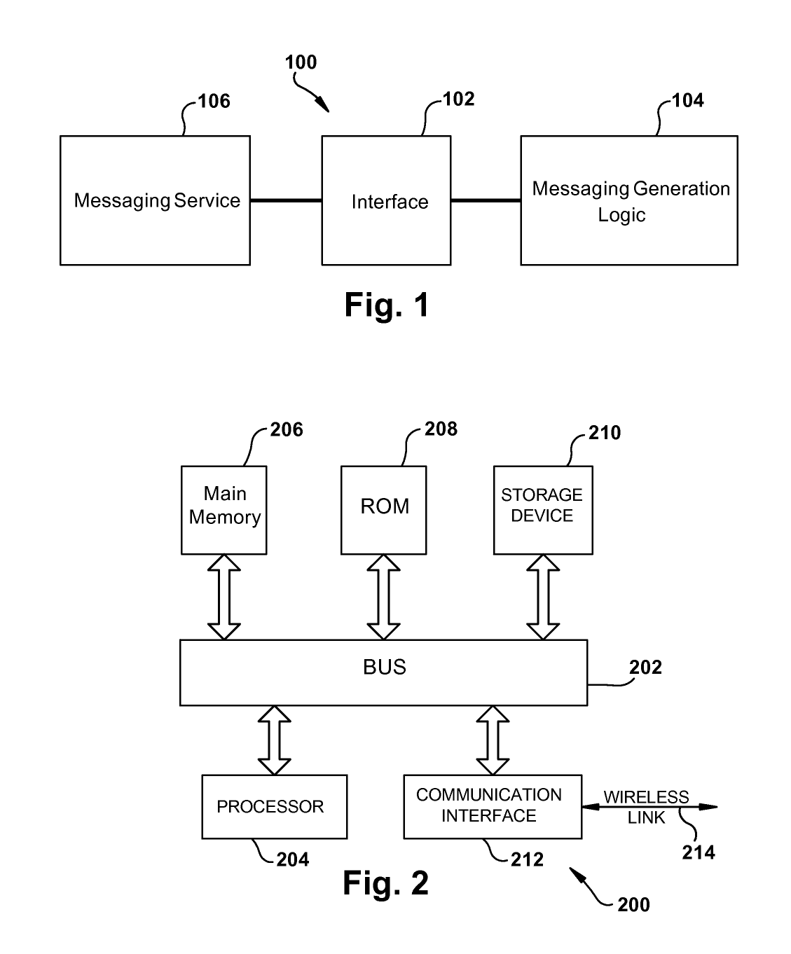

FIG. 1 is a block diagram illustrating an example of a system for blind sharing of content via a messaging service. The system 100 comprises an interface 102, message generation logic 104, and at least one associated messaging service 106 for sharing of content.

The interface 102 may be any suitable wired or wireless interface that can send and receive signals from a messaging service and the messaging generation logic. In the illustrated example, a single interface 102 is illustrated; however, those skilled in the art should readily appreciate that a single interface 102 is illustrated merely for ease of illustration and that the example embodiments described herein may suitably comprise any physically realizable number of interfaces 102.

Message generation logic receives data from at least one user or subscriber of a messaging service to generate content and share such content with a list of recipients designated by such user. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

The associated messaging service 106 may be any suitable messaging service that is operable to generate and share content created by a user or subscriber. In the illustrated example, a single messaging service 106 is illustrated; however, those skilled in the art should readily appreciate that a single messaging service 106 is illustrated merely for ease of illustration and that the example embodiments described herein may suitably comprise any physically realizable number of messaging services 106.

In an example embodiment, the message generation logic receives a request from a user to share specified content with at least one recipient. The request includes identification data associated with each recipient, such as user name, location, and the like, in order for the specified content to be shared with each designated recipient. The request from the user may be communicated to the message generation logic via any suitable means, such as via interface 102 or any other device or component capable of receiving and sending request data from a user.

In an example embodiment, the system includes a user interface for a user of the system operable to receive input from the user for the generation and sharing of content via the messaging service. For example, the user interface enables the user to input the content for sharing data relating to the recipients, to whom the content is to be shared, and any other data or information related to the sharing of the content. The user interface may further comprise a hardware or software driven menu. The user interface may be implemented within a specified messaging service, wherein user input is configured as determined by such messaging service. The user interface may also be implemented independently of any specified messaging service. In such an embodiment, the message generation logic may further be operable to format the user input as required for a specific messaging service on which the content is to be published, to send the user input to a specified messaging service as received, wherein the specified messaging service formats the input as required, or a combination thereof.

The user may access the user interface and provide input thereto by any suitable means. For example, the user may access the user interface via any personal computing device known in the art including, for example and without limitation, a laptop computer, a personal computer, a personal data assistant, a web-enabled cellular telephone, a smart phone, a proprietary network device, or other web-enabled electronic device. The personal computing device may further include software, hardware, or a suitable combination thereof configured to interact with at least one messaging service.

In an example embodiment, the message generation logic receives a request from a user to share content with a list of designated recipients via at least one messaging service. The user may provide the content in any suitable form, including, but not limited to, text based information, video content, audio content, audiovisual content, image content, or combinations thereof. The request includes selected identification information for each recipient, such as user name, location, or both. The request further includes a status designation for each recipient, wherein the recipient may be a public recipient or a private or blind recipient.

The request may further include content access rights for at least one recipient. In a particular embodiment, content access rights may be provided for all recipients, only public recipients, only blind recipients, or a combination thereof. In a particular embodiment, content access rights may be provided for all recipients, only public recipients, only blind recipients, or a combination thereof. In a particular embodiment, the request includes content access rights for each blind recipient. The content access rights determine how a recipient may interact with the content. As an example, the content access rights assigned to a particular blind recipient may only allow the blind recipient to view the content, or may allow the blind recipient to view and provide commentary as to the content. In a particular embodiment, the content access rights for blind recipients may include viewing the content, modifying the content, forwarding at least a portion of the content to at least one additional recipient, providing additional content or commentary, or combinations thereof. As an example, a blind recipient may be able to view the content and forward or share the content with others, but may not provide commentary to the content or modify the content.

The request may further include information for each recipient as to the messaging service with which such recipient is associated or is a subscriber. As an example, the user may designate multiple recipients to receive the content, and the designated recipients may not all be associated with or a subscriber of the same messaging service.

In an example embodiment, upon receipt of request data from a user to share content with a list of designated recipients, the message generation logic determines a format for delivering the content to each of the recipients based on recipient status, and then the message generation logic formats the content for each recipient accordingly. As an example, the format for the content for a public recipient may be different from the format for a blind recipient as will be illustrated below.

In another example embodiment, upon receipt of request data from a user to share content with a list of designated recipients, wherein the request data includes content access rights for at least one recipient, the message generation logic determines a format for delivering the content to each of the recipients further based on each recipient's content access rights, and then the message generation logic formats the content for each recipient accordingly. For example, in the request data, the user may specify that certain blind recipients only have certain rights to access the content, such as to view only.

In another example embodiment, upon receipt of request data from a user to share content with a list of designated recipients, wherein the request data includes a messaging service associated with at least one recipient, the message generation logic determines a format for delivering the content to each of the recipients further based on a messaging service associated with each recipient, and then the message generation logic formats the content for each recipient accordingly. For example, a user may designate that content be delivered to a first recipient via a first social network messaging service, such as Facebook, and to a second recipient via a second social network messaging service, such as Twitter. In that instance, it is likely that each messaging service will likely have its own distinct format for publishing content, and the content for the first and second recipients must be formatted accordingly.

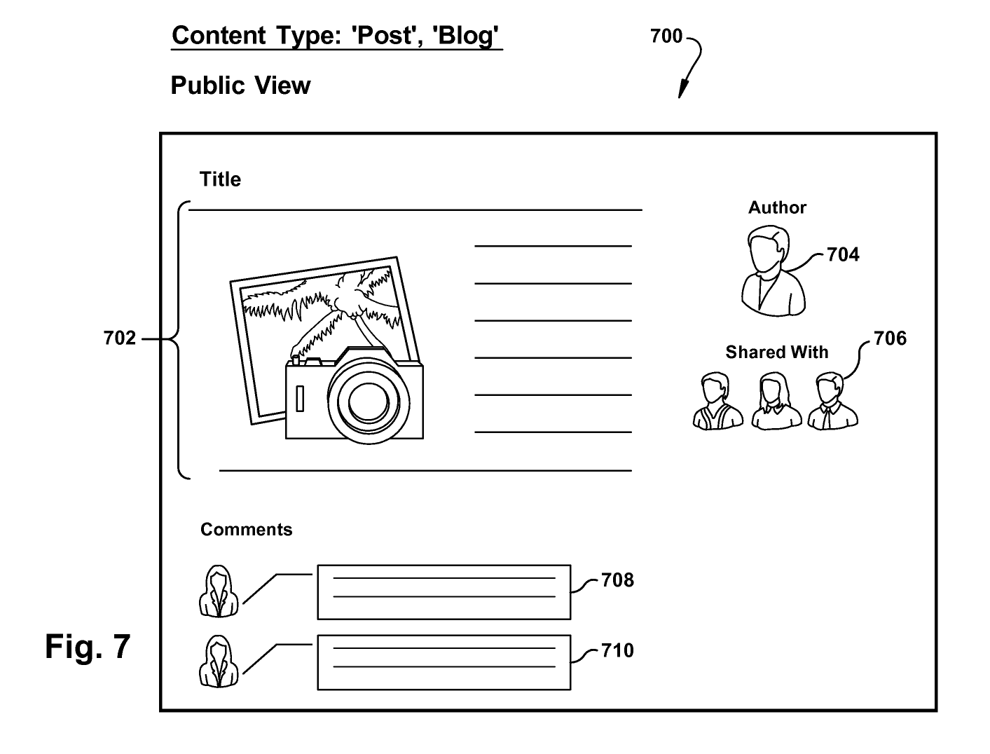

In an example embodiment, once the content has been formatted for each recipient, the message generation logic delivers the content to at least one messaging service in the determined format for each recipient. In a particular embodiment, the content is displayed or published via the associated messaging service, and includes identification information associated with each public recipient, such as the user name, location, or both, in the displayed content. In an example embodiment, the system filters or blocks identification information for each private or blind recipient, such that the displayed content does not include any identification information associated with any of the blind recipients. Examples of content published or displayed on a messaging service are illustrated in FIGS. 6-13 discussed in detail below.

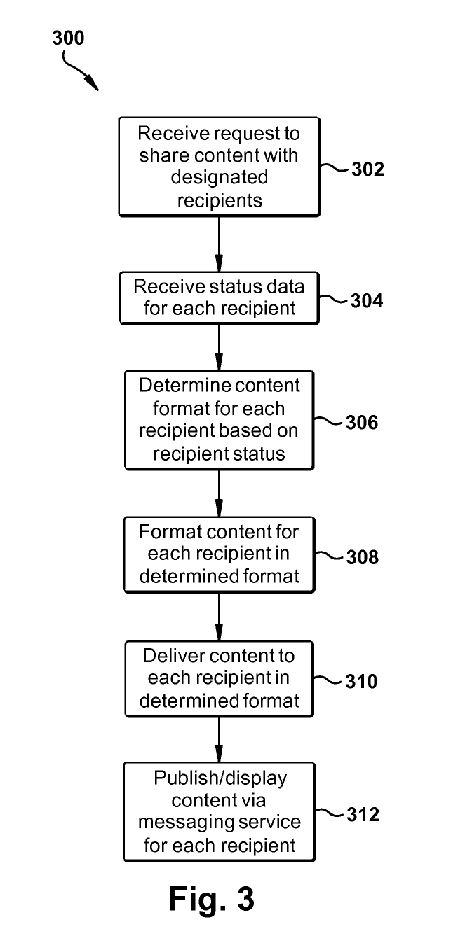

FIG. 2 is a block diagram that illustrates a computer system 200 upon which an example embodiment may be implemented. For example, computer system 200 may be employed for implementing the message generation logic 104 described herein in FIG. 1 above.

Computer system 200 includes a bus 202 or other communication mechanism for communicating information and a processor 204 coupled with bus 202 for processing information. Computer system 200 also includes a main memory 206, such as random access memory (RAM) or other dynamic storage device coupled to bus 202 for storing information and instructions to be executed by processor 204. Main memory 206 also may be used for storing a temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk, optical disk, and/or flash storage, is provided and coupled to bus 202 for storing information and instructions.

An aspect of the example embodiment is related to the use of computer system 200 for blind sharing of content via a messaging service. According to an example embodiment, automating the identification of meeting attendees is provided by computer system 200 in response to processor 204 executing one or more sequences of one or more instructions contained in main memory 206. Such instructions may be read into main memory 206 from another computer-readable medium, such as storage device 210. Execution of the sequence of instructions contained in main memory 206 causes processor 204 to perform the process steps described herein. One or more processors in a multi-processing arrangement may also be employed to execute the sequences of instructions contained in main memory 206. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 204 for execution. Such a medium may take many forms, including but not limited to non-volatile media, and volatile media. Non-volatile media include, for example, optical or magnetic disks, such as storage device 210. Volatile media include dynamic memory such as main memory 206. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 200 also includes a communication interface 212 coupled to bus 202. Communication interface 212 provides a two-way data communication coupling computer system 200 to communication link 214. Communication link 214 typically provides data communication to other networks or devices. For example, communication interface 212 may be a local area network (LAN) card to provide a data communication connection to a compatible LAN. As another example, communication interface 212 may be an integrated services digital network (ISDN) card or a modem to provide a data communication connection to a corresponding type of telephone line. Wireless links may also be implemented. In any such implementation, communication interface 212 sends and receives electrical, electromagnetic, or optical signals that carry digital data streams representing various types of information. Although the illustrated example has one communication interface 212 and one communication link 214, those skilled in the art should readily appreciate that this is for ease of illustrating as the example embodiments described herein may have any physically realizable number of communication interfaces 212, and/or communication links 214.

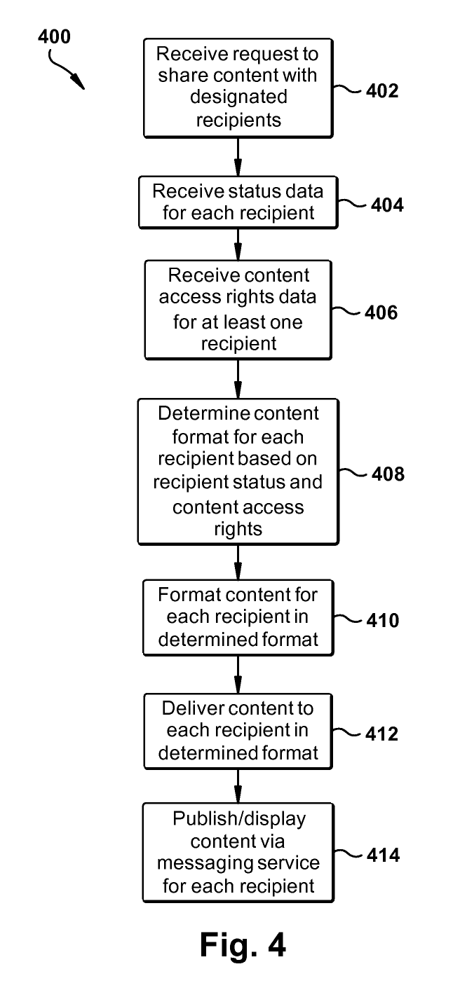

In view of the foregoing structural and functional features described above, methodologies in accordance with example embodiments will be better appreciated with reference to FIGS. 3-5. While, for purposes of simplicity of explanation, the methodologies of FIGS. 3-5 are shown and described as executing serially, it is to be understood and appreciated that the example embodiment is not limited by the illustrated order, as some aspects could occur in different orders and/or concurrently with other aspects from that shown and described herein. Moreover, in accordance with an example embodiment, not all illustrated features may be required. The methodologies described herein are suitably adapted to be implemented in hardware, software, or a combination thereof. For example, the methods may be implemented by message generation logic 104 (FIG. 1) and/or by processor 204 (FIG. 2).

FIG. 3 is a flow chart of an example method 300 for blind sharing of content via a messaging service. Method 300 may suitably be implemented on a blind sharing of content system as described herein.

At 302, request data is received from a user to share content with a list of designated recipients via at least one messaging service. The request data includes identification data associated with each recipient, such as user name, location, and the like, in order for the specified content to be shared with each designated recipient. The user may provide the content in any suitable form, including, but not limited to, text based information, video content, audio content, audiovisual content, image content, or combinations thereof. The request from the user may be communicated via any suitable means, such as via interface, or any other device or component capable of receiving and sending request data from a user.

At 304, status data is received from the user of a status designation for each recipient, wherein the recipient may be a public recipient or a private or blind recipient. While shown as a separate step in FIG. 3, the status data may be received concurrently with the request data. The status data may be communicated via any suitable means, such as via interface, or any other device or component capable of receiving and sending data from a user.

At 306, an appropriate or compatible format is determined for each designated recipient based on the status of such recipient. As an example, the format for the content for a public recipient may be different from the format for a blind recipient. At 308, in response to determining an appropriate format for each recipient, the content is formatted for each recipient accordingly.

At 310, the content is then delivered or shared with each recipient in the format determined for that recipient. At 312, the content is published or displayed via the messaging service for each recipient. In a particular embodiment, the content is displayed or published via the associated messaging service, and includes identification information associated with each public recipient, such as the user name, location, or both, in the displayed content. In an example embodiment, the system filters or blocks identification information for each private or blind recipient, such that the displayed content does not include any identification information associated with any of the blind recipients. Examples of content published or displayed on a messaging service are illustrated in FIGS. 6-13 discussed in detail below.

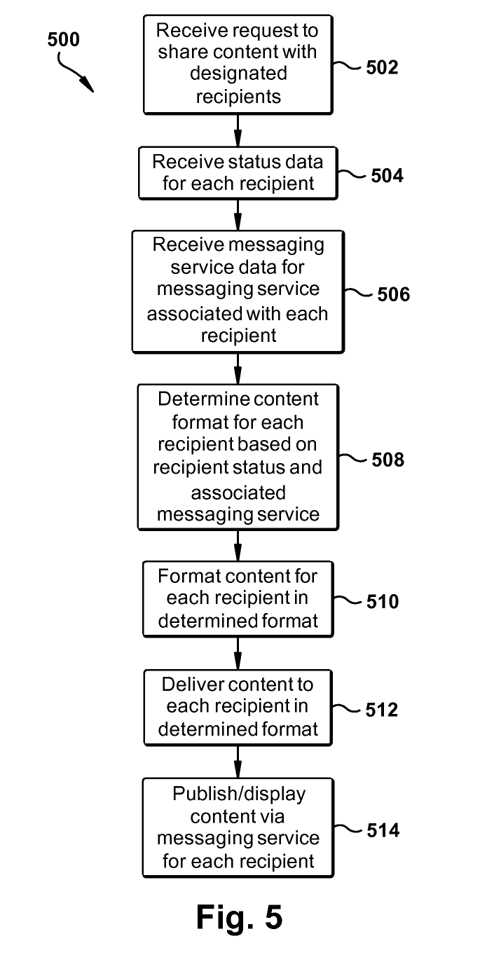

It is to be understood that a user may strategically designate the recipients to receive the content such that the user has control over the dissemination of the content. As an example, a user may desire that certain content be widely disseminated. In such an instance, the user may create content to be shared via an online social network messaging service. In such situation, the user would leverage his connections on such social network messaging service, as well as those of any subscribers to whom the content is to be shared. For example, the user would strategically designate which subscribers should be public recipients and which recipients should be blind recipients in order to maximize dissemination of the content. As an example, the user may designate as blind recipients those recipients the user knows would not want any identification information shared, but would be likely to share or further disseminate the content. Such blind recipients would in turn interact or further share the content over the social network messaging service, creating a ripple effect, causing the content to be shared between multiple generations of users, e.g. causing the content to go “viral”. FIG. 4 is a flow chart of an example method 400 for blind sharing of content via a messaging service, wherein such content includes content access permissions associated with at least one recipient. Method 400 may suitably be implemented on a blind sharing of content system as described herein.

At 402, request data is received from a user to share content with a list of designated recipients via at least one messaging service. The request data includes identification data associated with each recipient, such as user name, location, and the like, in order for the specified content to be shared with each designated recipient. The user may provide the content in any suitable form, including, but not limited to, text based information, video content, audio content, audiovisual content, image content, or combinations thereof. The request from the user may be communicated via any suitable means as discussed above with respect to FIG. 3.

At 404, status data is received from the user of a status designation for each recipient, indicating whether such recipient is a public recipient or a private or blind recipient. While shown as a separate step in FIG. 4, the status data may be received concurrently with the request data. The status data may be communicated via any suitable means as discussed above with respect to FIG. 3.

At 406, content access rights data is received from the user of the content access rights or permission of each recipient with respect to the content. The content access rights determine how a recipient may interact with the content, as discussed above. In a particular embodiment, content access rights may be provided for all recipients, only public recipients, only blind recipients, or a combination thereof. In a particular embodiment, content access rights may be provided for each blind recipient. While shown as a separate step in FIG. 4, the content access rights data may be received concurrently with the request data, the status data, or both. The content access rights data may be communicated via any suitable means, such as via interface, or any other device or component capable of receiving and sending data from a user.

At 408, an appropriate or compatible format is determined for each designated recipient based on the status of such recipient and the content access rights for such recipient. At 410, in response to determining an appropriate format for each recipient, the content is formatted for each recipient accordingly.

At 412, the content is then delivered or shared with each recipient in the format determined for that recipient. At 414, the content is published or displayed via the messaging service for each recipient.

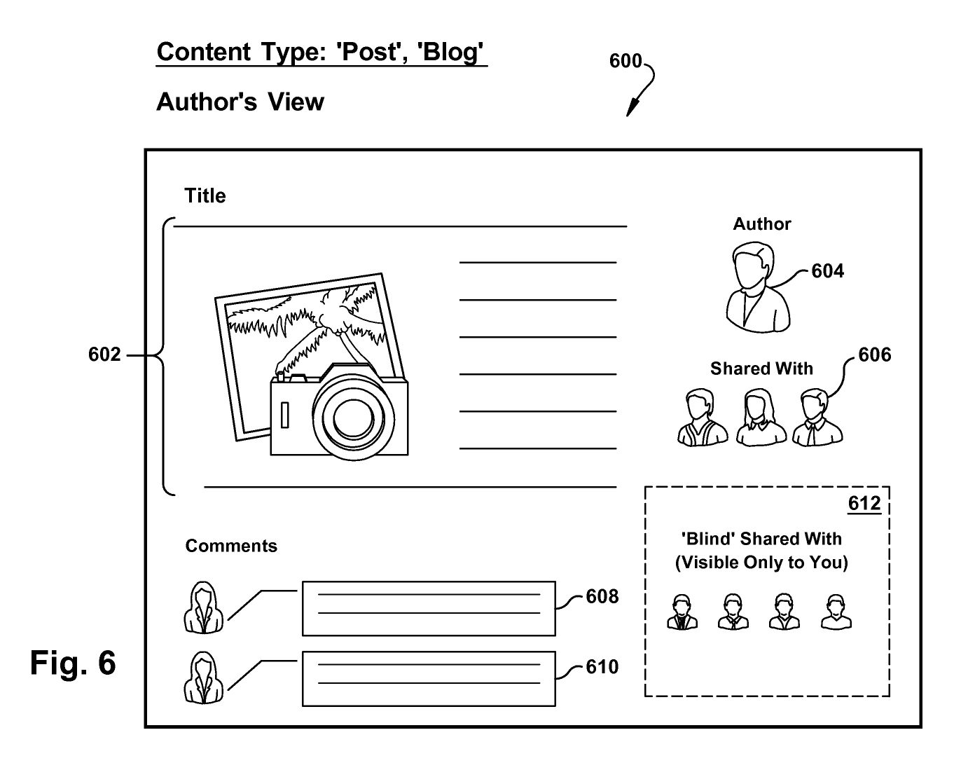

FIG. 5 is a flow chart of an example method 500 for blind sharing of content via a messaging service, wherein the content is delivered to a plurality of messaging services. Method 500 may suitably be implemented on a blind sharing of content system as described herein.

At 502, request data is received from a user to share content with a list of designated recipients via at least one messaging service. The request data includes identification data associated with each recipient, such as user name, location, and the like, in order for the specified content to be shared with each designated recipient. The user may provide the content in any suitable form, including, but not limited to, text based information, video content, audio content, audiovisual content, image content, or combinations thereof. The request from the user may be communicated via any suitable means as discussed above with respect to FIG. 3.

At 504, status data is received from the user of a status designation for each recipient, indicating whether such recipient is a public recipient or a private or blind recipient. While shown as a separate step in FIG. 5, the status data may be received concurrently with the request data. The status data may be communicated via any suitable means as discussed above with respect to FIG. 3.

At 506, messaging service data is received from the user of a messaging service for each recipient with which such recipient is associated or is a subscriber. As an example, the user may designate multiple recipients to receive the content, and the designated recipients may not all be associated with or a subscriber of the same messaging service. While shown as a separate step in FIG. 5, the messaging service data may be received concurrently with the request data, the status data, or both. The messaging service data may be communicated via any suitable means, such as via interface, or any other device or component capable of receiving and sending data from a user.

At 508, an appropriate or compatible format is determined for each designated recipient based on the status of such recipient and the associated messaging service for such recipient. At 510, in response to determining an appropriate format for each recipient, the content is formatted for each recipient accordingly.

At 512, the content is then delivered or shared with each recipient in the format determined for that recipient. At 514, the content is published or displayed via the messaging service for each recipient.

Examples of content published or displayed on a messaging service are illustrated in FIGS. 6-13 provide examples of content published or displayed on a messaging service in accordance with the system and methods set forth herein. In reference to FIGS. 6-13, for purposes of simplicity of explanation, the user that creates and shares the content, will be referred to herein as “author”.

FIGS. 6-8 illustrate an example display of shared content via a messaging service in accordance with one example embodiment. In this embodiment, the author creates content to be shared on a messaging service, such as an update or status on a social network service. The author designates selected recipients to receive the content according to the system and methods set forth herein. Such updates may be shared throughout the messaging service, or only shared within a select group of recipients. In this example, the author has designated certain recipients as public recipients and certain other recipients as blind recipients. The author has also designated limited content access rights or permissions for selected blind recipients, which in this example, is the ability to only view the content. Such blind recipients may only view the content and all interactions associated therewith, such as commentary provided by public recipients. The blind recipients may not modify the content, provide commentary to the content, share the content with others, or take any other actions with respect to the content.

FIG. 6 illustrates an example display 600 of shared content on a messaging service as viewed by the author of the content. As an example, if the author were to log into the author's account on the messaging service in which the content was published, the author would see the display 600. The display for the author includes the shared content 602 as specified by the author, identification information for the author 604, and identification information for each public recipient 606. The display further includes commentary provided, if any, to the content as shown by 608 and 610. The display also includes identification information for blind recipients 612.

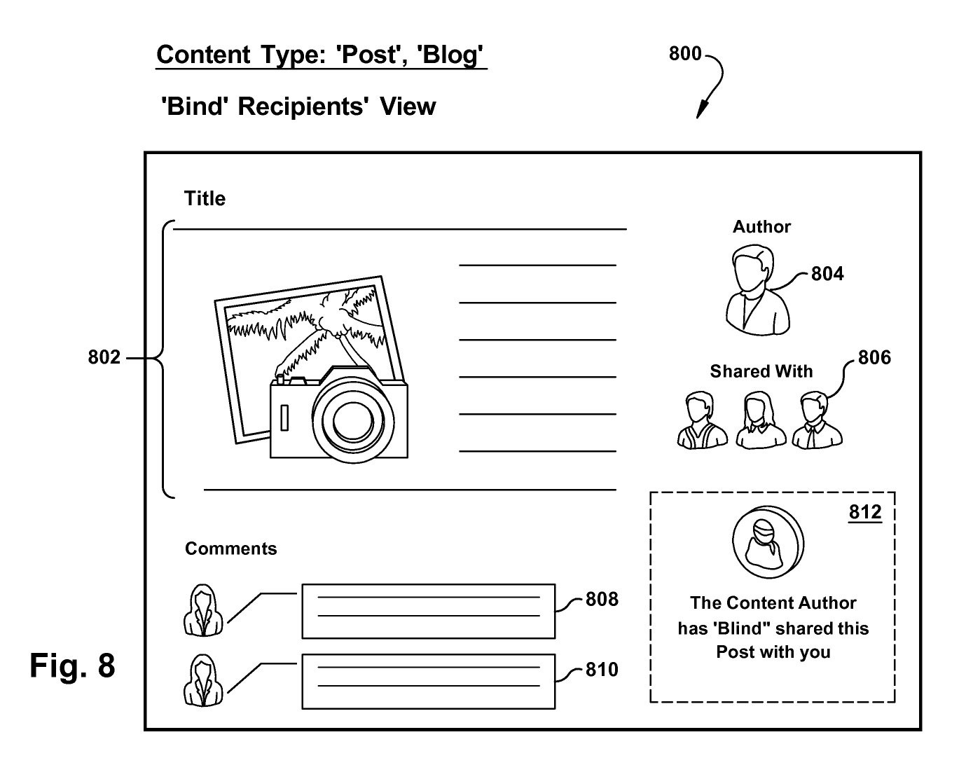

FIG. 7 illustrates an example display 700 of shared content on a messaging service as viewed by a public recipient of the content. As an example, if such public recipient were to log into the public recipient's account on the messaging service in which the content was published, the public recipient would see the display 700. The display for the public recipient includes the shared content 702, identification information for the author 704, and identification information for each public recipient 706. The display further includes commentary provided, if any, to the content as shown by 708 and 710. It is to be noted, that unlike display 600, which is the display as viewed by the author, display 700 does not include any identification information for any of the blind recipients. This information has been filtered out or blocked from displaying in any content viewed by a public recipient.

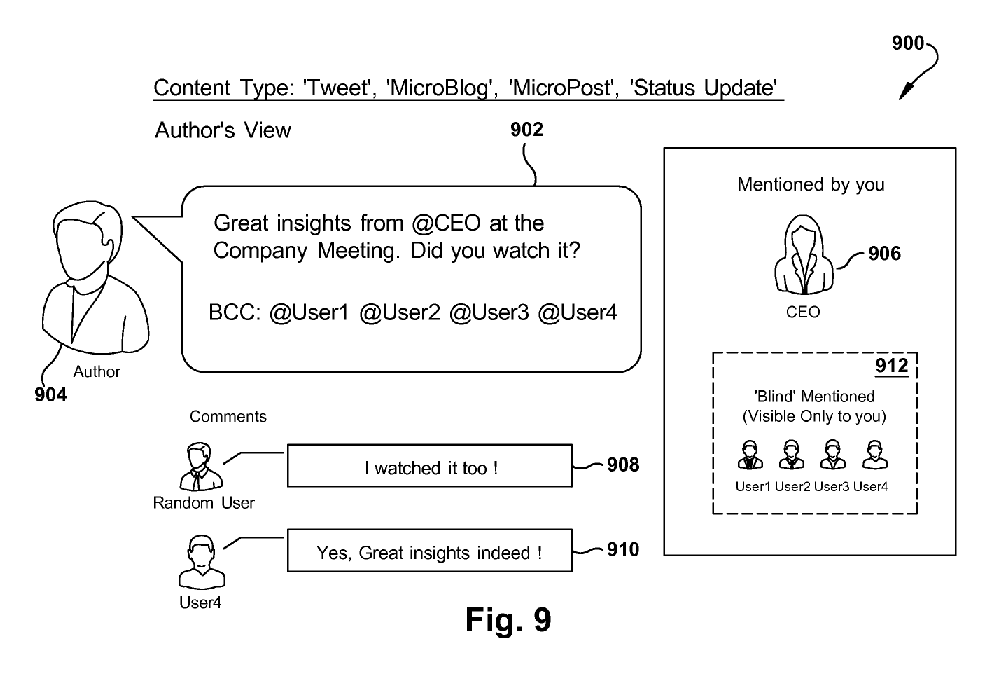

FIG. 8 illustrates an example display 800 of shared content on a messaging service as viewed by a blind recipient 1 of the content. As an example, if blind recipient 1 were to log into the blind recipient's account on the messaging service in which the content was published, blind recipient 1 would see the display 800. The display for blind recipient 1 includes the shared content 802, identification information for the author 804, and identification information for each public recipient 806. The display further includes commentary provided, if any, to the content as shown by 808 and 810. The display also includes selected identification information for blind recipient 1 812, illustrating that the author blind shared the information with blind recipient 1. It is to be noted, that unlike display 600, which is the display as viewed by the author, display 800 does not include any identification information for any of the other blind recipients. This information has been filtered out or blocked from displaying in any content viewed by any recipients other than the author and blind recipient 1.

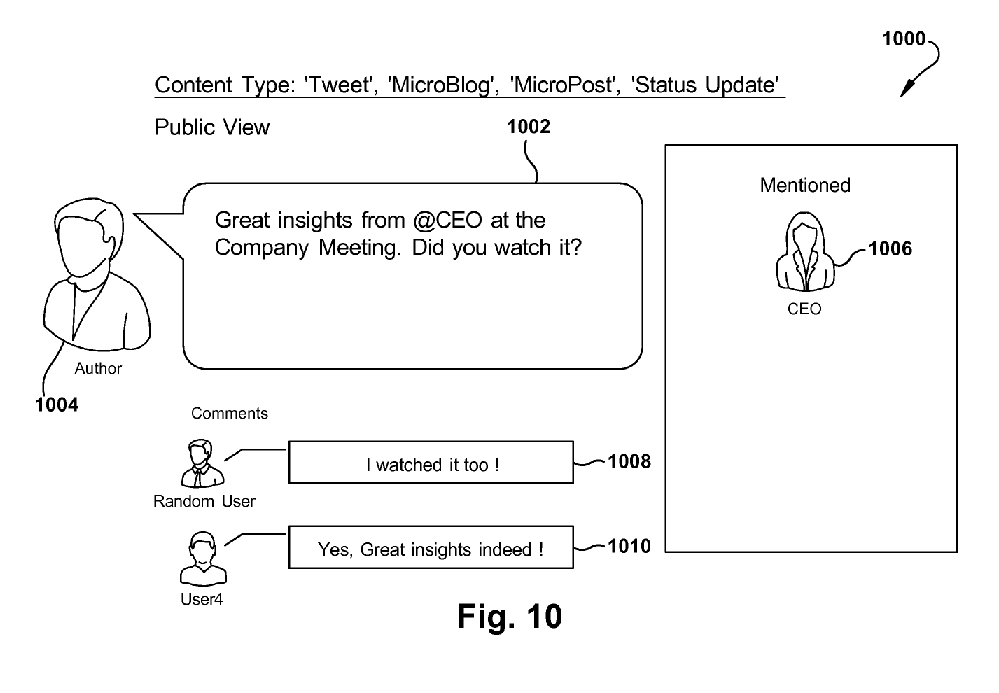

FIGS. 9-11 illustrate an example display of shared content via a messaging service in accordance with one example embodiment. In this embodiment, the author creates content to be shared on a messaging service, such as a commentary or update on a social network service, such as Twitter. The author designates selected recipients to be mentioned in or provide commentary on the content according to the system and methods set forth herein. In this example, the update is intended to be shared throughout the messaging service. In this example, the author has designated certain recipients as public recipients and certain other recipients as blind recipients. The author has also designated limited content access rights or permissions for selected blind recipients, which in this example, is the ability to provide commentary to the content. It is to be noted in this example, that any commentary provided by such blind recipients will be able to be viewed by all subscribers of the messaging service.

FIG. 9 illustrates an example display 900 of shared content on a messaging service as viewed by the author of the content. As an example, if the author were to log into the author's account on the messaging service in which the content was published, the author would see the display 900. The display for the author includes the shared content 902 as specified by the author, identification information for the author 904, and identification information for each public recipient 906 mentioned in the content. The display further includes commentary provided, if any, to the content as shown by 908 and 910. In this example, any subscriber to the messaging service may provide commentary, not just the public recipients, as noted by commentary 908 provided by a random subscriber and commentary 910 by a blind recipient (User4). The display also includes identification information for blind recipients 912.

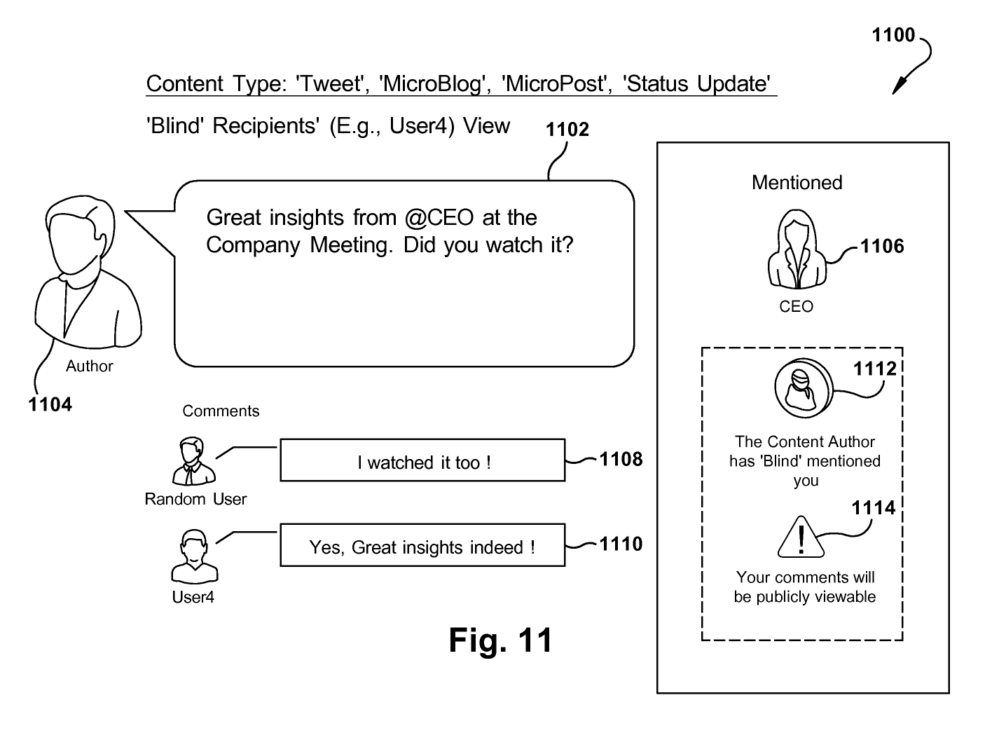

FIG. 10 illustrates an example display 1000 of shared content on a messaging service as viewed by a public recipient of the content. As an example, if such public recipient were to log into the public recipient's account on the messaging service in which the content was published, the public recipient would see the display 1000. The display for the public recipient includes the shared content 1002, identification information for the author 1004, and identification information for each public recipient 1006. The display further includes commentary provided, if any, to the content as shown by 1008 and 1010. It is to be noted, that unlike display 900, which is the display as viewed by the author, display 1000 does not include any identification information for any of the blind recipients. This information has been filtered out or blocked from displaying in any content viewed by a public recipient.

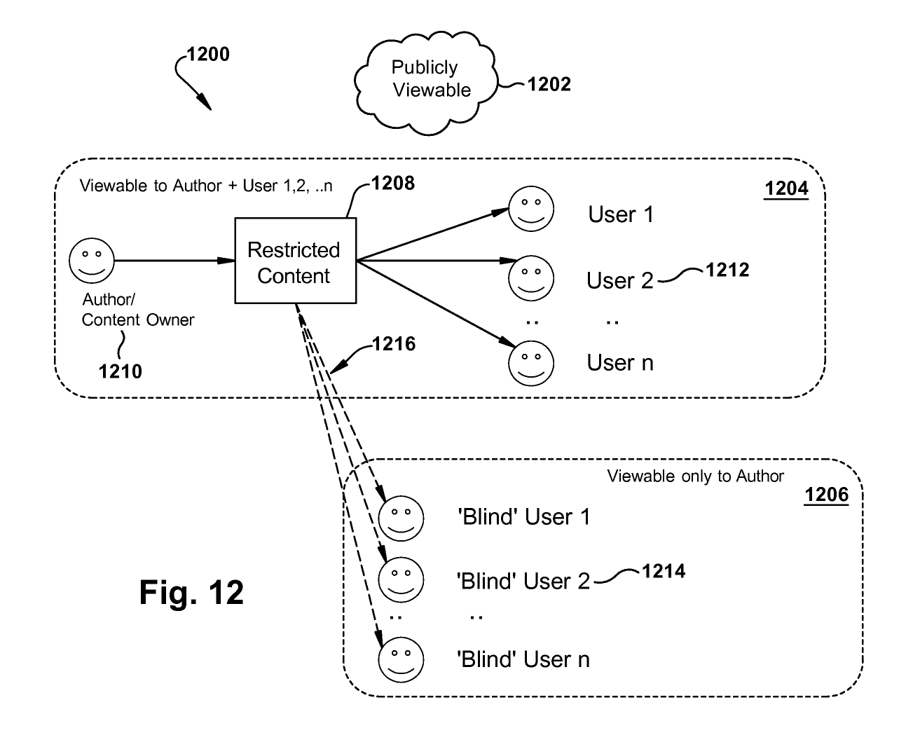

FIG. 11 illustrates an example display 1100 of shared content on a messaging service as viewed by a blind recipient 1 of the content. As an example, if blind recipient 1 were to log into the blind recipient's account on the messaging service in which the content was published, blind recipient 1 would see the display 1100. The display for blind recipient 1 includes the shared content 1102, identification information for the author 1104, and identification information for each public recipient 1106. The display further includes commentary provided, if any, to the content as shown by 1108 and 1110. The display also includes selected identification information for blind recipient 1 1112, illustrating that the author blind shared the information with blind recipient 1. It is to be noted, that unlike display 900, which is the display as viewed by the author, display 1100 does not include any identification information for any of the other blind recipients. This information has been filtered out or blocked from displaying in any content viewed by any recipients other than the author and blind recipient 1. The display also includes a warning 1114 to blind recipient 1 that any commentary provided by blind recipient 1 will be able to be viewed by all subscribers to the messaging service.

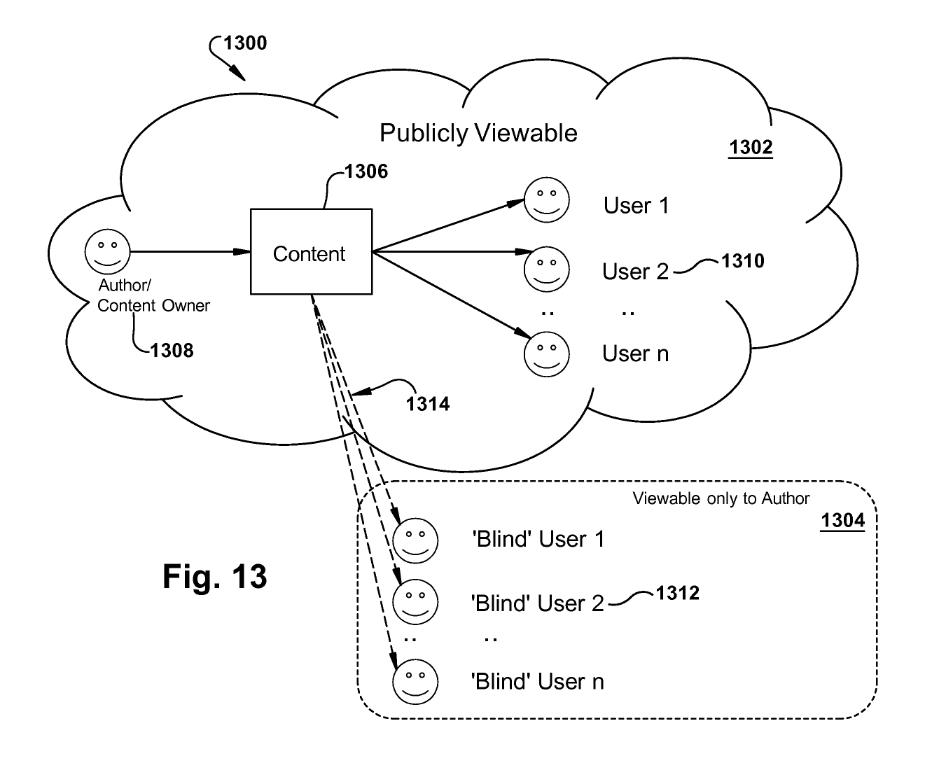

FIG. 12 illustrates an example of shared content via a messaging service wherein the content is shared only amongst a select group of subscribers of a messaging service in accordance with one example embodiment. In this embodiment, the author creates content to be shared on a messaging service illustrated as 1200, such as an update or status on a social network service. The author designates selected recipients to receive the content according to the system and methods set forth herein. In this example, such updates are only shared within a select group of subscribers of the messaging service, and therefore, cannot be viewed by subscribers outside of the group. For example, an author may create content to be shared on a company intranet and only with those employees with certain credentials. As an example, a group leader of a confidential project may only want to share data with those team members on the project, referred to as “Project Team A”. In this example, the author has designated certain recipients as public recipients and certain other recipients as blind recipients. The author has also designated limited content access rights or permissions for selected blind recipients.

The messaging service 1200, includes content or information that is available to all subscribers of the messaging service as indicated by 1202, content or information that is available only to members of Project Team A, as shown by 1204, and content or information that is only available to the author as shown at 1206. In this example, the author creates content to be shared, and such content is only to be shared with recipients or subscribers within a certain group or meeting certain criteria. The author designates certain recipients as public recipients and other recipients as blind recipients. The content is then shared with the designated recipients according to the system and methods set forth herein.

The shared content as shown at 1208 is able to be viewed only by the author and the designated recipients on Project Team A as illustrated by 1204. The shared content may not be viewed by any subscriber of the messaging service not on Project Team A, as illustrated by 1202. In addition, identification information for the author as shown at 1210 and identification information for each of the public recipients as shown at 1212, is also provided to the designated recipients.

Information about the blind recipients is only viewable by the author, as illustrated at 1206, and includes identification information for each of the blind recipients as shown at 1214. As discussed above, identification information for any of the blind recipients is not provided to any of the public recipients. In addition, identification information for a blind recipient is not provided to any other blind recipient. A blind recipient only has his own identification information. Only the author has access to the identification information for all of the blind recipients.

The blind recipients of the shared content will be able to view the shared content as illustrated by 1216. The content access rights provided to each blind recipient will determine how such recipient may interact with the content.

It should be noted that in this example, the author may not share the content with any recipient, either public or blind, that is not on Project Team A. If the author desires to share the content with a recipient not on Project Team A, such recipient must first be provided the proper credentials or access in order to access the content.

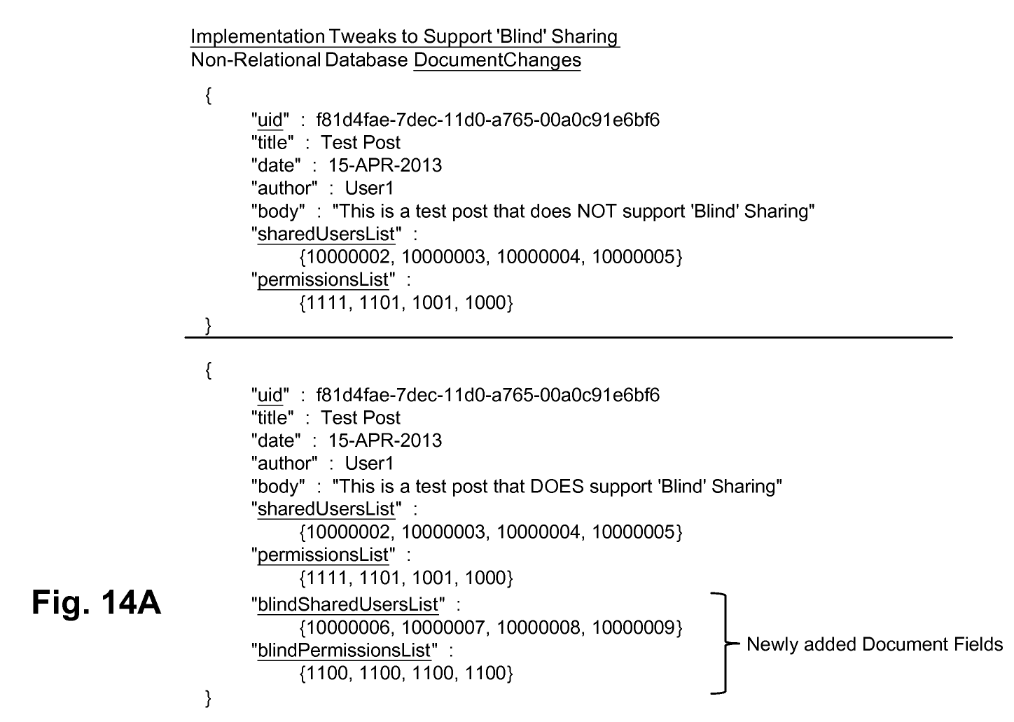

FIG. 13 illustrates an example of shared content via a messaging service wherein the content is shared to all subscribers of a messaging service in accordance with one example embodiment. In this embodiment, the author creates content to be shared on a messaging service illustrated as 1300, such as an update or status on a social network service. The messaging service 1300, includes content or information that is available to all subscribers of the messaging service as indicated by 1302, and content or information that is only available to the author as shown at 1304. The author designates selected recipients to receive the content according to the system and methods set forth herein. In this example, such updates may be shared with all subscribers of the messaging service. In this example, the author has designated certain recipients as public recipients and certain other recipients as blind recipients. The author has also designated limited content access rights or permissions for selected blind recipients. The content is then shared with the designated recipients according to the system and methods set forth herein.

The shared content as shown at 1306 is able to be viewed by any subscriber of the messaging service as shown at 1302. In addition, identification information for the author as shown at 1308 and identification information for each of the public recipients as shown at 1310, is also able to be viewed by any subscriber of the messaging service.

Information about the blind recipients is only viewable by the author, as illustrated at 1304, and includes identification information for each of the blind recipients as shown at 1312. As discussed above, identification information for any of the blind recipients is not provided to any of the public recipients. In addition, identification information for a blind recipient is not provided to any other blind recipient. A blind recipient only has his own identification information. Only the author has access to the identification information for all of the blind recipients.

The blind recipients of the shared content will be able to view the shared content as illustrated by 1314. The content access rights provided to each blind recipient will determine how such recipient may interact with the content.

The system and method for blind sharing of content via a messaging service is suitably implemented as part of an existing mechanism for creation of content, providing update or status information, providing commentary, or other types of information to a social networking messaging service. Current social network messaging services typically use a data model which stores a list of recipients to receive content from a user as a bitmap with the associated content access rights for each recipient. It is understood that such data models will suitably be modified to support storage of blind recipients as well as the content access rights for each blind recipient as is known in the art.

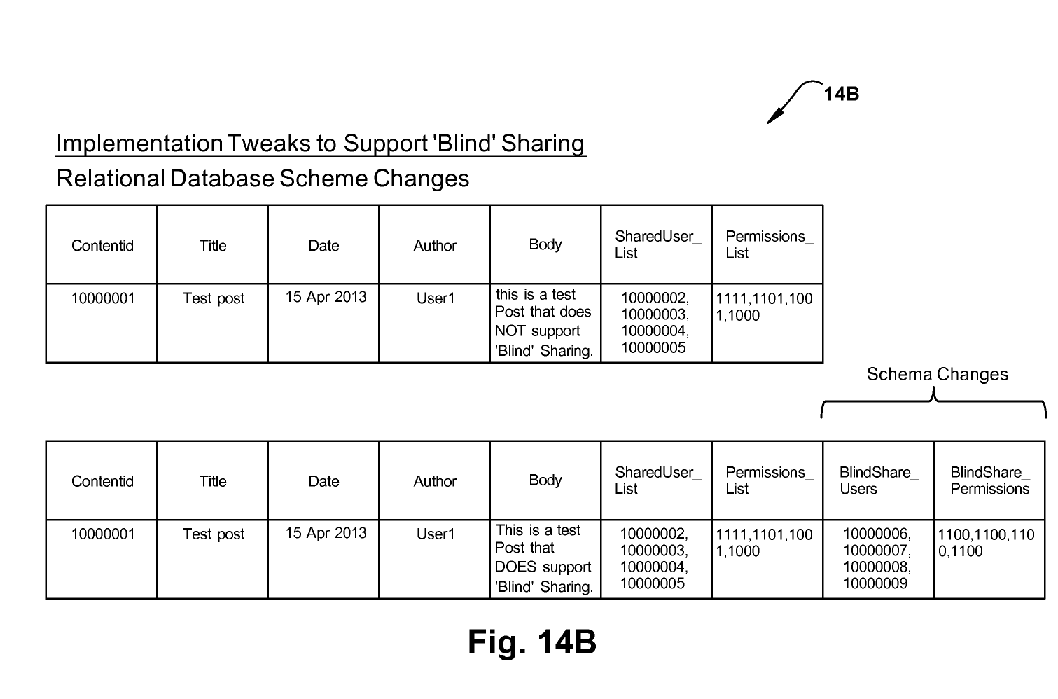

For example if the existing content model for an example social network messaging service is stored in a relational database, the data scheme would suitably be modified to support storage of blind recipient identification information and the content access rights for each blind recipient. An example of such modification to a relational database module is illustrated in FIG. 14A. As shown in FIG. 14A, the relational database schema is modified to include storage for blind recipient identification information and content access rights associated therewith.

As an example, if the existing content model for an example social network messaging service is stored in a non-relationship database, such as a document, the document may be suitable annotated with additional fields to support storage of blind recipient identification information and content access rights associated therewith. As shown in FIG. 14B, the document is annotated to include the storage for blind recipient identification information and content access rights associated therewith.

It is further understood any messaging service would suitably be modified to filter out or block the identity of each blind recipient based on the status of viewer as is known in the art.

Advantageously, the system and method described herein allow a user or author to create and share content with designated recipients, in a format as determined for each user. Further, designating certain recipients as blind recipients, allows the content to be shared with such recipients, while protecting the privacy of such recipients. The blind recipients are able to interact or further share the content with others in the recipients' networks, leading to a broader dissemination of the content.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
an interface;
message generation logic coupled with the interface and operable to communicate with at least one associated messaging service;
the message generation logic receives data representative of a request to send content to at least one designated recipient, the request data including identification information for each designated recipient;
the message generation logic receives data representative of recipient status for each recipient, the recipient status including information as to whether such recipient is a blind recipient;
the message generation logic determines a format for delivering the content to each of the recipients based on recipient status;
the message generation logic formats the content for each recipient in accordance with the determined format for each recipient; and
the message generation logic delivers the content to each recipient in the determined format.

2. The apparatus of claim 1, the message generation logic further displays the content on an associated messaging service, the displayed content including identification data associated with at least one public recipient.

3. The apparatus of claim 2, the message generation logic further filters out identification data associated with at least one blind recipient such that identification data of the at least one blind recipient is not displayed with the content.

4. The apparatus of claim 1, wherein the messaging service is an online social network messaging service.

5. The apparatus of claim 1, wherein the request data includes information for a messaging service associated with each recipient to which content is to be delivered.

6. The apparatus of claim 5, wherein the message generation logic determines the format for delivering the content to each one of the recipients further based on a messaging service associated with each recipient to which content is to be delivered, and formats the content for each recipient in accordance with the determined format for each recipient.

7. The apparatus of claim 1, the message generation logic further receives data representative of content access rights for each blind recipient responsive to receiving status data that at least one recipient is a blind recipient.

8. The apparatus of claim 7, wherein the message generation logic determines a format for delivering the content to each blind recipient further based on content access rights and formats the content for each recipient in accordance with the determined format for each blind recipient.

9. The apparatus of claim 7, wherein content access rights for each blind recipient are selected from the group consisting of viewing the content, modifying the content, forwarding at least a portion of the content to at least one additional recipient, providing additional content, and combinations thereof.

10. The apparatus of claim 1, wherein the content is comprised of at least one of text based information, video content, audio content, audiovisual content, and image content.

11. A method, comprising:
receiving data representative of a request to send content to at least one designated recipient, the request data including identification information for each designated recipient;
receiving data representative of recipient status for each recipient, the recipient status including information as to whether such recipient is a blind recipient;
determining a format for delivering the content to each of the recipients based on recipient status;
formatting the content for each recipient in accordance with the determined format for each recipient; and
delivering the content to each recipient in the determined format.

12. The method of claim 11, further comprising displaying the content on an associated messaging service, the displayed content including identification data associated with at least one public recipient.

13. The method of claim 12, further comprising filtering out identification data associated with at least one blind recipient such that such identification data is not displayed with the content.

14. The method of claim 11, wherein the messaging service is an online social network messaging service.

15. The method of claim 11, wherein the request data includes information for a messaging service associated with each recipient to which content is to be delivered.

16. The method of claim 15, further comprising determining the format for delivering the content to each one of the recipients further based on a messaging service associated with each recipient to which content is to be delivered, and formatting the content for each recipient in accordance with the determined format for each recipient.

17. The method of claim 11, further comprising receiving data representative of content access rights for each blind recipient responsive to receiving status data that at least one recipient is a blind recipient.

18. The method of claim 17, further comprising determining a format for delivering the content to each blind recipient further based on content access rights, and formatting the content for each recipient in accordance with the determined format for each blind recipient.

19. The method of claim 17, wherein content access rights for each blind recipient is selected from the group consisting of viewing the content, modifying the content, forwarding at least a portion of the content to at least one additional recipient, providing additional content, and combinations thereof.

20. The method of claim 11, wherein the content is comprised of at least one of text based information, video content, audio content, audiovisual content, and image content.

21. Logic encoded in a tangible, non-transitory computer readable medium for execution by a processor, and when executed operable to:
receive data representative of a request to send content to at least one designated recipient, the request data including identification information for each designated recipient;
receive data representative of recipient status for each recipient, the recipient status including information as to whether such recipient is a blind recipient;
determine a format for delivering the content to each of the recipients based on recipient status;
format the content for each recipient in accordance with the determined format for each recipient; and
deliver the content to each recipient in the determined format.

22. The logic of claim 21, the logic further operable to display the content on an associated messaging service, the displayed content including identification data associated with at least one public recipient.

23. The logic of claim 22, the logic further operable to filter out identification data associated with at least one blind recipient such that such identification data is not displayed with the content.

24. The logic of claim 21, the logic further operable to receive data representative of content access rights for each blind recipient responsive to receiving status data that at least one recipient is a blind recipient.
